(19) United States
(12) Patent Application Publication
(10) Pub. No.: US 2026/0025537 A1
(43) Pub. Date: Jan. 22, 2026

(54) REWINDS BASED ON TRANSCRIPTS

(71) Applicant: Google LLC, Mountain View, CA (US)

(72) Inventor: Florian Nils Hartmann, Zurich (CH)

(21) Appl. No.: 18/774,526

(22) Filed: Jul. 16, 2024

(51) Int. Cl. H04N 21/2387

(52) U.S. Cl. CPC H04N 21/2387

(57) ABSTRACT

A computing system receives a transcript for a video and an input indicative of a request to adjust a playback position of the video, in which the request does not specify a timestamp of the video to which to adjust the playback position. The computing system applies, based on the request to adjust the playback position, a first machine learning model to the transcript and a current timestamp of the video to identify one or more noncurrent time stamps. The computing system applies a second machine learning model to the transcript, the current timestamp, and the one or more noncurrent time stamps to rank, based on user data, the one or more noncurrent time stamps. The computing system then adjusts, based on the ranking of the one or more noncurrent timestamps, the playback position to a noncurrent timestamp from the one or more noncurrent timestamps.

### BACKGROUND

When watching videos, users often have the capability to rewind or fast-forward a video to re-watch a scene, re-listen to dialogue, skip scenes, jump to a particular timestamp, etc. Video playback is typically performed in a fixed number of seconds (e.g., a user may rewind or fast-forward in intervals of 10 seconds). When a user rewinds several times in a row, this number of seconds may be increased by some multiplier (e.g., triple tapping the rewind button may rewind the video by 30 seconds). However, adjusting playback based on fixed time intervals may result in overshooting, in which users may end up watching portions of the video that they had no desire to re-watch. Furthermore, users may have to request several playback adjustments before they reach their desired timestamp of the video, which may worsen user experience. As such, it may be beneficial to adjust video playback based on factors other than fixed time intervals.

### SUMMARY

In general, techniques of this disclosure describe techniques for performing video rewinds and/or fast-forwards based on user preferences. In some examples, a computing system may apply a machine learning model to a video transcript and a machine learning model to user data. The computing system may receive a transcript for a video and an input (e.g., a user input) indicating a request to adjust a playback position of the video (e.g., a request to rewind or fast-forward the video). The computing system may apply a first machine learning model (e.g., a transcript-matching model) to the transcript and a current timestamp of the video to identify one or more noncurrent time stamps (e.g., previous timestamps or future time stamps). For example, previous timestamps may include a start time stamp for a current sentence, a start time stamp for a current dialogue, and a start time stamp for a current scene. Future time stamps may include a start time stamp for a future sentence, a start time stamp for a future dialogue, and a start time stamp for a future scene. The computing system may apply a second machine learning model to the transcript, the current timestamp, and the one or more noncurrent time stamps to rank, based on user data, the one or more noncurrent time stamps. For example, the noncurrent time stamps may be ranked based on a user’s preferences when adjusting a playback position (e.g., a preference to rewind to start time stamps for a current scene, a preference to rewind to start time stamps for a current sentence, etc.). Based on the ranking of the one or more noncurrent timestamps, the computing system may adjust the playback position to a noncurrent timestamp from the one or more noncurrent timestamps.

In this way, the computing system described herein may dynamically interpret user intent, and therefore eliminate the need for users to manually input specific timestamps for adjusting video playback position, and/or eliminate the process of adjusting video playback position solely based on set time intervals. Furthermore, by using the machine learning methods described herein, the computing system may not only intelligently and accurately determine relevant points in a video, but also tailor playback adjustments to individual user preferences. As such, the techniques described herein may reduce the likelihood of overshooting or undershooting the desired video playback position, which may result in users not having to repeatedly provide manual adjustments to receive their desired video playback position. Thus, overall usability, accessibility, and user satisfaction of the video playback system may be improved.

In one example, the disclosure is directed toward a method that includes receiving, by a computing system, a transcript for a video, receiving, by the computing system, an input indicative of a request to adjust a playback position of the video, wherein the request does not specify a timestamp of the video to which to adjust the playback position, and applying, by the computing system, and based on the request to adjust the playback position, a first machine learning model to the transcript and a current timestamp of the video to identify one or more noncurrent time stamps. The method may also include applying, by the computing system, a second machine learning model to the transcript, the current timestamp, and the one or more noncurrent time stamps to rank, based on user data, the one or more noncurrent time stamps, and adjusting, by the computing system and based on the ranking of the one or more noncurrent timestamps, the playback position to a noncurrent timestamp from the one or more noncurrent timestamps.

In another example, the disclosure is directed toward a computing system that includes one or more processors, and one or more storage devices that store instructions. The instructions, when executed by the one or more processors, may cause the one or more processors to receive a transcript for a video, and receive an input indicative of a request to adjust a playback position of the video, wherein the request does not specify a timestamp of the video to which to adjust the playback position. The instructions may further cause the one or more processors to apply, based on the request to adjust the playback position, a first machine learning model to the transcript and a current timestamp of the video to identify one or more noncurrent time stamps, apply a second machine learning model to the transcript, the current timestamp, and the one or more noncurrent time stamps to rank, based on user data, the one or more noncurrent time stamps, and adjust, based on the ranking of the one or more noncurrent timestamps, the playback position to a noncurrent timestamp from the one or more noncurrent timestamps.

In another example, the disclosure is directed toward a non-transitory computer-readable storage medium encoded with instructions. The instructions, when executed by the one or more processors, may cause the one or more processors to receive a transcript for a video, and receive an input indicative of a request to adjust a playback position of the video, wherein the request does not specify a timestamp of the video to which to adjust the playback position. The instructions may further cause the one or more processors to apply, based on the request to adjust the playback position, a first machine learning model to the transcript and a current timestamp of the video to identify one or more noncurrent time stamps, apply a second machine learning model to the transcript, the current timestamp, and the one or more noncurrent time stamps to rank, based on user data, the one or more noncurrent time stamps, and adjust, based on the ranking of the one or more noncurrent timestamps, the playback position to a noncurrent timestamp from the one or more noncurrent timestamps.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing system configured to receive user input indicating a request to adjust a playback position of a video, in accordance with one or more techniques of this disclosure.

FIG. 2 is a block diagram illustrating an example computing system configured to apply a machine learning model for adjusting playback position of a video, in accordance with one or more techniques of this disclosure.

FIG. 3 is a conceptual diagram illustrating an example machine learning module for adjusting playback position of a video based on user data and the video transcript, in accordance with one or more techniques of this disclosure.

FIG. 4 is a conceptual diagram illustrating an example computing system configured to adjust playback position of a video based on user data and the video transcript, in accordance with one or more techniques of this disclosure.

FIG. 5 is a flowchart illustrating an example operation of a computing system configured to receive user input indicating a request to adjust a playback position of a video, in accordance with one or more techniques of this disclosure.

### DETAILED DESCRIPTION

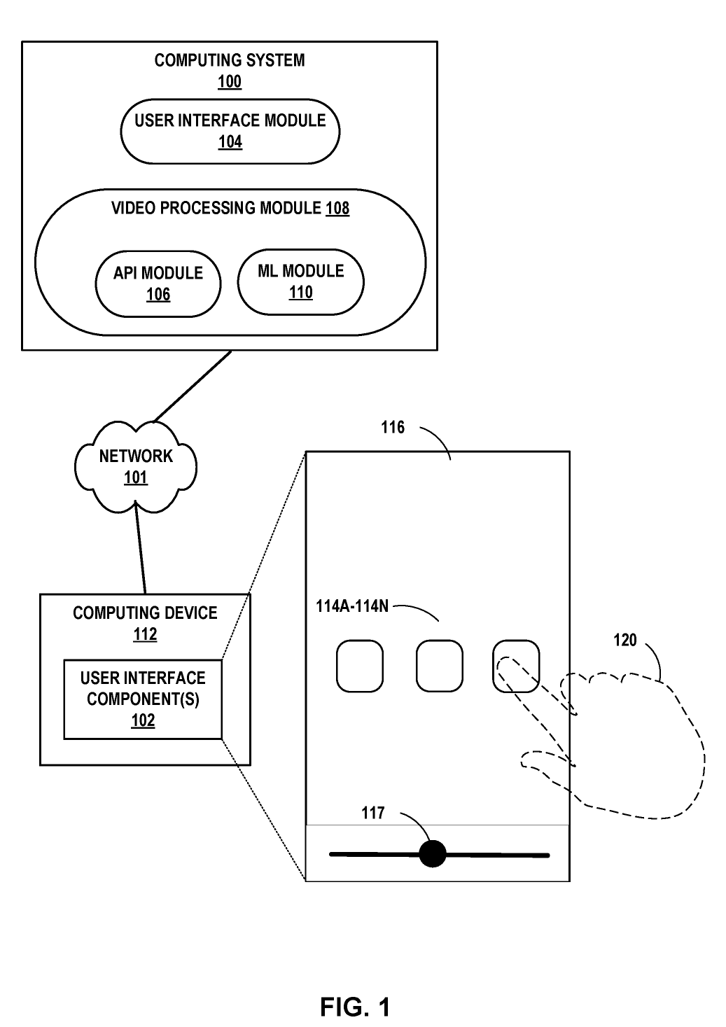

FIG. 1 is a conceptual diagram illustrating an example computing system configured to receive user input indicating a request to adjust a playback position of a video, in accordance with one or more techniques of this disclosure. In general, computing system 100 of FIG. 1 may perform video rewinds and/or fast-forwards based on user preferences by applying a machine learning model to a video transcript and a machine learning model to user data.

In the example of FIG. 1, a user 120 interacts with computing device 112 that is in communication with computing system 100. In some examples, some or all of the components and/or functionality attributed to computing system 100 may be implemented or performed by computing device 112. While not explicitly shown in the example of FIG. 1, computing system 100 may be implemented on a plurality of computing devices that may include, but are not limited to, portable, mobile, or other devices, such as mobile phones (including smartphones), laptop computers, desktop computers, tablet computers, smart television platforms, server computers, mainframes, etc. In some examples, computing system 100 may represent a cloud computing system that provides one or more services via network 101. That is, in some examples, computing system 100 may be a distributed computing system.

As described above, some or all of the components and/or functionality attributed to computing system 100 may be implemented or performed by computing device 112. The computing system 100 may communicate with computing device 112 via network 101. Network 101 may include any public or private communication network, such as a cellular network, Wi-Fi network, a direct cell-to-satellite communication network, or other type of network for transmitting data between computing system 100 and computing device 112. In some examples, network 101 may represent one or more packet switched networks, such as the Internet. Computing device 112 may send and receive data to and from computing system 100 across network 101 using any suitable communication techniques. For example, computing system 100 and computing device 112 may each be operatively coupled to network 101 using respective network links. Network 101 may include network hubs, network switches, network routers, etc., that are operatively inter-coupled thereby providing for the exchange of information between computing device 112 and computing system 100. In some examples, network links of network 101 may be Ethernet, ATM or other network connections. Such connections may include wireless and/or wired connections, including satellite network connections.

As shown in the example of FIG. 1, computing device 112 includes one or more user interface (UI) components (“UI components 102”). UI components 102 of computing device 112 may be configured to function as input devices and/or output devices for computing device 112. UI components 102 may be implemented using various technologies. For instance, UI components 102 may be configured to receive input from user 120 through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from user 120. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure sensitive screen, an acoustic pulse recognition touch screen, or another presence-sensitive technology. That is, UI components 102 of computing device 112 may include a presence-sensitive device that may receive tactile input from user 120. UI components 102 may receive indications of the tactile input by detecting one or more gestures from user 120 (e.g., when user 120 touches or points to one or more locations of UI components 102 with a finger or a stylus pen).

UI components 102 may additionally or alternatively be configured to function as an output device by providing output to user 120 using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to user 120. Additional examples of an output device include a speaker, a haptic device, or other device that can generate intelligible output to a user. For instance, UI components 102 may present output to user 120 as a graphical user interface that may be associated with functionality provided by computing device 112. In this way, UI components 102 may present various user interfaces of applications executing at or accessible by computing device 112 (e.g., an electronic message application, an Internet browser application, etc.). User 120 may interact with a respective user interface of an application to cause computing device 112 to perform operations relating to a function provided by the application.

In some examples, UI components 102 of computing device 112 may detect two-dimensional and/or three-dimensional gestures as input from user 120. For instance, a sensor of UI components 102 may detect the user's movement (e.g., moving a hand, an arm, a pen, a stylus, etc.) within a threshold distance of the sensor of UI components 102. UI components 102 may determine a two- or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1, computing system 100 includes user interface (UI) module 104. UI module 104 may perform operations described herein using hardware, software, firmware, or a mixture thereof residing in and/or executing at computing system 100. Computing system 100 may execute UI module 104 with one processor or with multiple processors. In some examples, computing system 100 may execute UI module 104 as a virtual machine executing on underlying hardware. UI module 104 may execute as one or more services of an operating system or computing platform or may execute as one or more executable programs at an application layer of a computing platform.

UI module 104, as shown in the example of FIG. 1, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI components 102, to provide output based on the data. For instance, UI module 104 may send data to UI components 102 of computing device 112 to display a GUI, such as GUI 116.

Computing system 100 may receive a transcript for a video being played on computing device 112 via UI components 102. For example, the video may be displayed to a user via a generated user interface (GUI) 116 on a display screen of computing device 112. A user (e.g., user 120) may interact with GUI 116 to provide an input indicating a request to adjust a playback position of the video. For example, user 120 may interact with one of buttons 114A-114N of GUI 116, in which each of buttons 114A-114N may correspond to a video playback feature (it should be noted that throughout the examples described herein, GUI 116 may include some or all of buttons 114A-114N, or may include additional similar components not shown in FIG. 1). For example, computing device 112 may receive an indication of a gesture from user 120 that is detected at button 114A, in which the indication of the gesture is provided by user 120 manually through a tap on the screen. In some examples, the indication of a gesture may be an audible input, in which the gesture is provided by user 120 via, for example, voice command. For example, a user may say the command “rewind” or “fast-forward.” The indication may then be sent to computing system 100, in which computing system 100 may then execute the techniques described herein for playback of the video displayed by GUI 116 to user 120. For example, if user 120 interacts with button 114A, computing system 100 may receive an input indicating a request to rewind the video, and if user 120 interacts with button 114B, computing system 100 may receive an input indicating a request to fast-forward the video. In some examples, the indication of the gesture is provided by user 120 by using gesture control, such as by providing the gestures described above (e.g., a hand-wave, a pinch, a clap, a pen stroke, etc.) or by tapping the screen in a certain manner (e.g., triple tapping the screen). As such, the techniques described herein for adjusting video playback may be executed by computing system 100 in response to an indication of a variety of gestures. In this way, a user may not be required to perform a certain gesture in order to adjust video playback, which may cause video playback to be much more accessible and user-friendly to the user.

In general, when watching videos, users often request to rewind or fast-forward a video to re-watch a scene, re-listen to dialogue, skip scenes, jump to a particular timestamp, etc. Video playback is typically performed in a fixed number of seconds (e.g., a user may rewind or fast-forward in intervals of 10 seconds) or performed based on a timestamp specified manually by a user (e.g., when a user drags a slider across a “seek bar” or “scrubber bar” to adjust position in the video timeline). When a user rewinds several times in a row, this number of seconds may be increased by some multiplier (e.g., triple tapping the rewind button may rewind the video by 30 seconds). However, adjusting playback based on fixed time intervals may result in overshooting, in which users may end up watching portions of the video that they had no desire to re-watch. Furthermore, users may have to request several playback adjustments before they reach their desired timestamp of the video, which may worsen user experience.

When user 120 interacts with GUI 116 to provide an input indicating a request to adjust a playback position of a video, the video displayed via GUI 116 may be adjusted by computing system 100 based on factors other than fixed time intervals. Specifically, video processing module 108 of computing system 100 may retrieve video information (e.g., a video transcript, visual information pertaining to scenes included in the video, etc.) from computing device 112 via API module 106 and then apply ML module 110 to the retrieved video information. For example, in some examples, ML module 110 may apply a machine learning model to the transcript and/or visual data from the video to generate an augmented transcript including information indicative of one or more scenes included in the video. Specifically, ML module 110 may apply a first machine learning model (e.g., a transcript-matching model) to the transcript (or in some examples, the augmented transcript) and a current timestamp 117 of the video to identify one or more noncurrent time stamps (e.g., previous timestamps or future time stamps).

As described herein, video processing module 108 of computing system 100 may determine a video playback adjustment (e.g., one of the one or more noncurrent time stamps identified by ML module 110) based on user preferences and historical user data that indicates user 120’s tendency to rewind to previous timestamps, such as a start time stamp for a current sentence, a start time stamp for a current dialogue, a start time stamp for a current scene etc., and/or user 120’s tendency to fast-forward to future time stamps, such as a start time stamp for a future sentence, a start time stamp for a future dialogue, a start time stamp for a future scene, etc.

In general, user 120 is provided with an opportunity to provide input to control whether programs or features of computing device 112 and/or computing system 100 can collect and make use of user information (e.g., user 120’s personal data, information about user 114’s history, etc.), or to dictate whether and/or how computing device 112 and/or computing system 100 may receive content that may be relevant to user 120. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 112 and/or computing system 100 so that personally identifiable information is removed. For example, a user’s identity may be treated so that no personally identifiable information can be determined about the user, or a user’s geographic location may be generalized where location information is obtained (such as to a city, ZIP code, or state level), so that a particular location of a user cannot be determined. Thus, user 120 may have control over how information is collected about them and used by computing device 112 and/or computing system 100. For example, user 120 may be prompted by computing device 112 to provide explicit consent for computing device 112 and/or computing system 100 to retrieve and/or store any or all of user 120’s data.

As described above, with explicit consent from user 120, video processing module 108 may run continuously and be configured to monitor the video content of the active user interface of one or more applications. In an example involving computing device 112, with explicit consent from user 120, video processing module 108 may run continuously in the background of computing device 112 and be configured to monitor the video content of the active user interface of one or more applications executing at computing device 112. In other words, API module 106 receives explicit consent from user 120 to gather video information from one or more applications. As described above, video processing module 108 may analyze video information in response to a triggering input (e.g., an input provided mechanically (such as by pressing one of buttons 114A-114N), by gesture recognition/control (such as triple tapping on a screen by user 120), by audio (such as a verbal command), etc.), or automatically (such that no triggering user input is required), again provided that a user has given explicit permission for video processing module 108 to analyze the video content. In some examples, API module 106 may provide information about user interface elements, events, and actions to assistive technologies (e.g., screen readers, magnification gestures, switch devices, etc.) provided by video processing module 108. In some examples, API module 106 may be configured to enable the exchanging of data in a standardized format. For example, API module 106 may support REST (Representational State Transfer), which is a widely-used architectural style for building APIs that use HTTP (Hypertext Transfer Protocol) to exchange data between applications.

API module 106 may be configured to generate a stream of events as user 120 interacts with computing device 112 and applications executed on computing device 112. In some examples, these events may represent actions and changes in a user interface, such as button presses, text changes, and screen transitions (e.g., user 120 toggling between buttons 114A-114N on GUI 116, such as in the example of toggling between a rewind button and a fast-forward button). With explicit consent from user 120, video processing module 108 may receive and analyze these events to better understand how user 120 interacts with a video playing on computing device 112.

As described above, in the example of FIG. 1, user 120 operating computing device 112 may provide input to one or more of UI components 102, in which the user input indicates a request to adjust playback position of a video displayed by GUI 116. With explicit consent from user 120, computing system 100 may receive the user input and, in some examples, user data associated with user 120, and API module 106 of computing system 100 may retrieve a transcript of the video being displayed to user 120. In some examples, the information received by computing system 100 and retrieved by API module 106 from computing device 112 may be stored by computing system 100 to better understand user preferences. In some examples, API module 106 may retrieve visual data from the video to generate an augmented transcript including information indicative of one or more scenes included in the video. In some examples, API module 106 may be configured to retrieve descriptive text (i.e., content or scene descriptions) for videos based on images or icons.

ML module 110 of video processing module 108 may apply a first machine learning model (e.g., a transcript-matching model) to the transcript (or in some examples, the augmented transcript) and a current timestamp 117 of the video to identify one or more noncurrent time stamps (e.g., previous timestamps or future time stamps). Specifically, in some examples, ML module 110 may and identify one or more noncurrent timestamps that correspond to, for example, a start time stamp for a current sentence, a start time stamp for a current dialogue, a start time stamp for a current scene, a start time stamp for a future sentence, a start time stamp for a future dialogue, a start time stamp for a future scene, etc. In some examples, the one or more noncurrent timestamps may be identified based on the analysis of the transcript (and/or augmented transcript) and, additionally or alternatively, user preferences and historical user data that indicates user 120’s tendency to rewind to previous timestamps and/or user 120’s tendency to fast-forward to future time stamps.

As such, rather than adjusting playback position of a video to a specified noncurrent timestamp based on fixed time intervals (e.g., rewinding in increments of ten seconds) or a manual user input (e.g., a user dragging a slider across a “seek bar” or “scrubber bar” to a particular position in the video timeline), video processing module 108 may adjust video playback to one of the one or more noncurrent timestamps described above that are identified by ML module 110. Furthermore, in some examples, the request from user 120 may only specify whether a general rewinding or fast-forwarding should be performed rather than specify a specific timestamp to which the playback position of the video should be adjusted.

To determine a specific noncurrent timestamp to adjust the video playback to, ML module 110 may apply a second machine learning model to the transcript, current timestamp 117, and the one or more noncurrent time stamps to rank, based on user data and preferences, the one or more noncurrent time stamps. For example, as described above, the noncurrent time stamps may be ranked based on a user’s preferences when adjusting a playback position (e.g., a preference to rewind to start time stamps for a current scene, a preference to rewind to start time stamps for a current sentence, etc.). As an example, a first noncurrent timestamp may be a start time stamp for a current scene, which may be determined based on data indicating that user 120 is most likely to rewind to a start time stamp for a current scene. As an example, a second noncurrent time may be a start time stamp for a current sentence, which may be determined based on data indicating that user 120 is less likely to rewind to a start time stamp for a current sentence. Thus, in general, the first machine learning model may determine one or more noncurrent timestamps, and the second machine learning model may rank the one or more noncurrent timestamps, in which the ranking may be based on user preferences determined from user data.

As described above, in general, video processing module 108 may send information (e.g., location information, other contextual information, etc.) to ML module 110 only if computing system 100 receives permission from the user of computing device 112 to send the information. For example, in situations discussed here in which computing system 100 and/or computing device 112 may collect, transmit, or may make use of personal information about a user, the user may be provided with an opportunity to control whether programs or features of computing system 100 can collect user information or to control whether and/or how computing system 100 and/or computing device 112 may store and share user information. In addition, certain data may be treated in one or more ways before it is stored, transmitted, or used so that personally identifiable information is removed. For example, a user’s identity may be treated so that no personally identifiable information can be determined about the user. Thus, the user may have control over how information is collected about the user and stored, transmitted, and/or used in accordance with techniques of this disclosure.

Based on the ranking of the one or more noncurrent timestamps as determined by ML module 110, computing system 100 may adjust the playback position of the video to a noncurrent timestamp from the one or more noncurrent timestamps. In some examples, the noncurrent timestamp is a first-ranked noncurrent timestamp.

As such, by receiving a transcript for a video and an input indicative of a request to adjust the playback position without specifying a timestamp, computing system 100 can dynamically interpret user intent, allowing for more flexible and user-friendly interaction with video content. This may eliminate the need for users to manually input specific timestamps, thus simplifying the process of adjusting playback positions. Furthermore, applying a machine learning model to the transcript and the current timestamp to identify one or more noncurrent timestamps may enable computing system 100 to intelligently determine relevant points in the video, such as the start of a sentence, dialogue, or scene. As described throughout this disclosure, this approach may leverage natural language processing to enhance the accuracy and relevance of playback adjustments, as compared to traditional fixed-interval rewinds or fast-forwards.

By applying a second machine learning model to rank the identified noncurrent timestamps based on user data, computing system 100 may further tailor playback adjustments to individual user preferences. This personalized ranking may ensure that the most relevant timestamps are prioritized, thus improving user satisfaction and reducing the likelihood of overshooting or undershooting the desired playback position.

In this way, the techniques described herein for adjusting video playback position based on the ranked noncurrent timestamps may allow for a more intuitive and efficient user experience. Users can quickly navigate to meaningful points in the video without repeatedly adjusting the playback position, thereby enhancing the overall usability and accessibility of the video playback system.

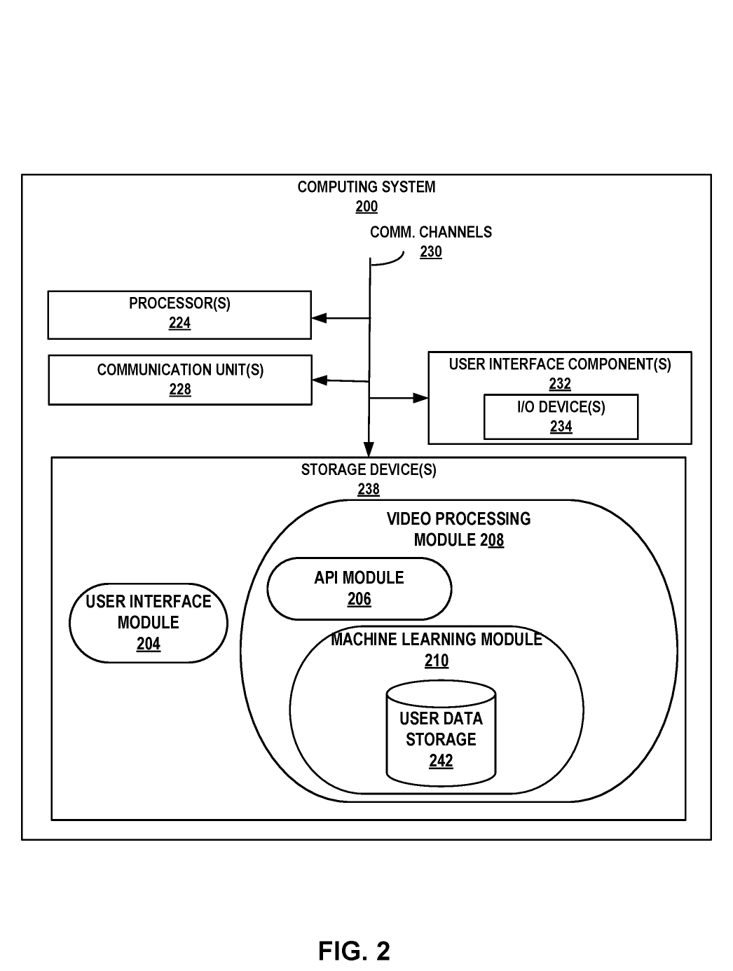

FIG. 2 is a block diagram illustrating an example computing system configured to apply a machine learning model for adjusting playback position of a video, in accordance with one or more techniques of this disclosure. As shown in the example of FIG. 2, computing system 200 includes processors 224, one or more communication channels 230, one or more user interface components (UIC) 232, one or more communication units 228, and one or more storage devices 238. Storage devices 238 of computing system 200 may include user interface module 204, and video processing module 208. As shown in the example of FIG. 2, video processing module 208 further includes API module 206, machine learning module 210, and user data storage 242. Some or all of the components and/or functionality attributed to computing system 200 may be implemented or performed by a computing device in communication with computing system 200. Computing system 200, user interface module 204, video processing module 208, API module 206, machine learning module 210, and user interface (UI) components 232 may be similar if not substantially similar to computing system 100, user interface module 104, video processing module 108, API module 106, machine learning module 110, and user interface (UI) components 102 of FIG. 1, respectively.

The one or more communication units 228 of computing system 200, for example, may communicate with external devices by transmitting and/or receiving data at computing system 200, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection as described above), one or more inter-process communication data structures, or any other components for communicating data between hardware and/or software locally or remotely.

One or more I/O devices 234 of computing system 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, video processing module 208, API module 206, machine learning module 210, and user data storage 242 (hereinafter “modules 204-242”) may perform operations described herein using software, hardware, firmware, or a mixture of hardware, software, and firmware residing in and executing on computing system 200 or at one or more other computing devices (e.g., a cloud-based application - not shown). For example, some or all of modules 204-242 may be included in and executable on a local computing device, such as computing device 112 of FIG. 1. As such, the techniques described herein may all be implemented locally on a computing device.

Computing system 200 may execute one or more of modules 204-242, with one or more processors 224 or may execute any or part of one or more of modules 204-242 as or within a virtual machine executing on underlying hardware. One or more of modules 204-242 may be implemented in various ways, for example, as a downloadable or pre-installed application, remotely as a cloud application, or as part of the operating system of computing system 200. Other examples of computing system 200 that implement techniques of this disclosure may include additional components not shown in FIG. 2.

In the example of FIG. 2, one or more processors 224 may implement functionality and/or execute instructions within computing system 200. For example, one or more processors 224 may receive and execute instructions that provide the functionality of UIC 232, communication units 228, one or more storage devices 238 and an operating system to perform one or more operations as described herein. For example, one or more processors 224 may receive and execute instructions that provide the functionality of some or all of modules 204-242 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing system 200 may store information, such as video information, user data, or other data discussed herein, for processing during the operation of computing system 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules 204-242 of FIG. 2.

As described with respect to FIG. 1, computing system 200 may receive user input indicating a request to adjust playback position of a video, and retrieve, using API module 206, a transcript of the video. In some examples, API module 206 may, with user consent, continuously retrieve video information, or retrieve the video information responsive to the input indicative of a request to adjust a playback position of the video. In some examples, the request may not specify a timestamp of the video to which to adjust the playback position.

UI module 204 may interpret the indication or other inputs detected at the computing device. UI module 204 may relay information about the inputs detected at the computing device to one or more associated platforms, operating systems, applications, and/or services executing at the computing device to cause the computing device to perform a function. UI module 204 may also receive information and instructions from one or more associated platforms, operating systems, applications, and/or services executing at the computing device (e.g., video processing module 208) for adjusting a playback position of a video. In addition, UI module 204 may act as an intermediary between the one or more associated platforms, operating systems, applications, and/or services executing at the computing device and various output devices of the computing device (e.g., speakers, LED indicators, vibrators, etc.) to produce output (e.g., graphical, audible, tactile, etc.) with the computing device.

Video processing module 208 may be implemented on a computing device in various ways. For example, video processing module 208 may be implemented as a downloadable or pre-installed application or “app.” In another example, video processing module 208 may be implemented as part of an operating system of a computing device.

User data storage 242 is a storage repository for the user data received by computing system 200 from a computing device via API module 206. As an example, the user data may include data indicative of one or more of a number of requests for rewinding the video and a number of requests for fast-forwarding the video. The user date may be stored in user data storage 242 for use by other modules of video processing module 208. For example, in some examples, a machine learning model employed by ML module 210, such as a model for determining user preferences, may be trained on the user data.

In some examples, user data storage 242 may operate, at least in part, as a cache for user data retrieved from computing device 112 (e.g., using one or more communication units 228) or other computing devices. In general, user data storage 242 may be configured as a database, flat file, table, or other data structure stored within storage device 238. In some examples, user data storage 242 is shared between various modules executing at computing system 200 (e.g., between one or more of modules 204-242 or other modules not shown in FIG. 2). In other examples, a different data repository is configured for a module executing at computing system 200 that requires a data repository. Each data repository may be configured and managed by different modules and may store data in a different manner. In some examples, computing system 200 may receive and store data from a computing device over a specified period of time.

In some implementations, the video information retrieved by API module 206 may be preprocessed, which may include extracting one or more additional features from raw data. For example, feature extraction techniques may be applied to the video information to generate one or more new, additional features.

Provided that videos typically include multiple frames associated with timestamps, the video information retrieved by API module 206 may be sequential in nature. In some instances, the sequential video information may be generated by sampling or otherwise segmenting a stream of video frames. For example, a segment of video frames may be associated with a particular scene, which may be determined by information included in the video transcript, such as dialogue from a new character, an introduction to a new setting, etc. Specifically, in some examples, ML module 210 may apply a machine learning model to the video transcript to generate an augmented transcript including information indicative of one or more scenes included in the video. ML module 210 may then provide the augmented transcript to a transcript matching model employed by ML module 210 as input.

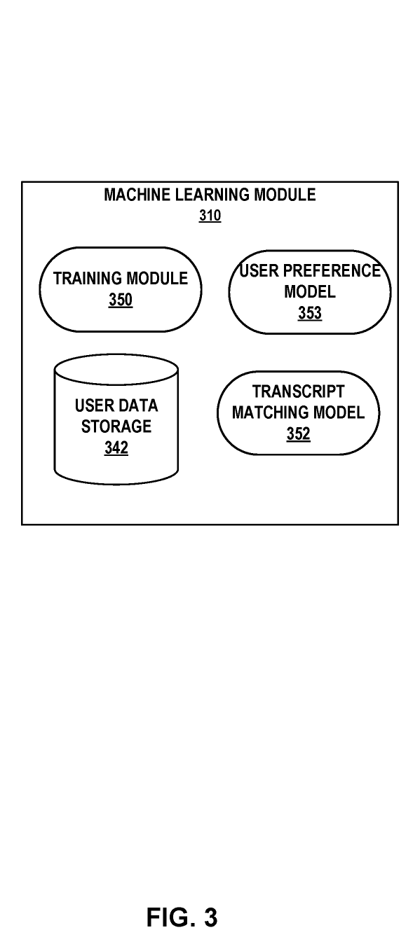

As described herein, ML module 210 may apply, based on the request to adjust the playback position, a machine learning model, such as a transcript matching model, to the transcript (and/or an augmented transcript as described above) and a current timestamp of the video to identify one or more noncurrent time stamps. ML module 210 may then apply an additional machine learning model to the transcript, the current timestamp, and the one or more noncurrent time stamps to rank, based on user data stored in user data storage 242, the one or more noncurrent time stamps. In some examples, machine learning module 210 may implement other machine-learned models that may be used in place of or in conjunction with the transcript matching model and user preference model, which are described later with respect to FIG. 3.

In general, machine learning module 210 may perform various types of video processing based on user data, user input, retrieved video information, or “input data”. In some examples, machine learning module 210 may summarize, translate, or organize the input data. Machine learning module 210 may use recurrent neural networks (RNNs) and/or transformer models (self-attention models), such as GPT-3, BERT, and T5. In some implementations, machine learning module 210 may perform classification, summarization, name generation, regression, clustering, anomaly detection, recommendation generation, and/or other tasks.

In some implementations, machine learning module 210 may perform various types of classification based on the input data. For example, machine learning module 210 may perform binary classification or multiclass classification. In binary classification, the output data may include a classification of the input data into one of two different classes. In multiclass classification, the output data may include a classification of the input data into one (or more) of more than two classes. The classifications may be single-label or multi-label. Machine learning module 210 may perform discrete categorical classification in which the input data is simply classified into one or more classes or categories.

In cases in which machine learning module 210 performs classification, machine learning module 210 may be trained using supervised learning techniques. For example, machine learning module 210 may be trained on a training dataset that includes training examples labeled as belonging (or not belonging) to one or more classes.

In some implementations, machine learning module 210 may perform regression to provide output data in the form of a continuous numeric value. The continuous numeric value may correspond to any number of different metrics or numeric representations, including, for example, currency values, scores, or other numeric representations. In examples, machine learning module 210 may perform linear regression, polynomial regression, or nonlinear regression. In examples, machine learning module 210 may perform simple regression or multiple regression. As described above, in some implementations, a Softmax function or other function or layer may be used to squash a set of real values respectively associated with two or more possible classes to a set of real values in the range (0, 1) that sum to one.

Machine learning module 210 may perform various types of clustering. For example, machine learning module 210 may identify one or more clusters to which the input data most likely corresponds. Machine learning module 210 may identify one or more clusters within the input data. That is, in instances in which the input data includes multiple objects, documents, or other entities, machine learning module 210 may sort the multiple entities included in the input data into a number of clusters. In some implementations in which machine learning module 210 performs clustering, machine learning module 210 may be trained using unsupervised learning techniques.

Machine learning module 210 may, in some cases, act as an agent within an environment. For example, machine learning module 210 may be trained using reinforcement learning, which will be discussed in further detail below.

In some implementations, machine learning module 210 may include a parametric model while, in other implementations, machine learning module 210 may include a non-parametric model. In some implementations, machine learning module 210 may include a linear model while, in other implementations, machine learning module 210 may include a non-linear model.

As described above, machine learning module 210 may be or include one or more of various different types of machine-learned models. Examples of such different types of machine-learned models are provided below for illustration. One or more of the example models described below may be used (e.g., combined) to provide the output data in response to the input data. Additional models beyond the example models provided below may be used as well.

In some implementations, machine learning module 210 may be or include one or more classifier models such as, for example, linear classification models; quadratic classification models; etc. Machine learning module 210 may be or include one or more regression models such as, for example, simple linear regression models; multiple linear regression models; logistic regression models; stepwise regression models; multivariate adaptive regression splines; locally estimated scatterplot smoothing models; etc.

In some implementations, machine learning module 210 may be or include one or more artificial neural networks (also referred to simply as neural networks). A neural network may include a group of connected nodes, which also may be referred to as neurons or perceptrons. A neural network may be organized into one or more layers. Neural networks that include multiple layers may be referred to as “deep” networks. A deep network may include an input layer, an output layer, and one or more hidden layers positioned between the input layer and the output layer. The nodes of the neural network may be connected or non-fully connected.

In some examples, machine learning module 210 may be or include one or more generative networks such as, for example, generative adversarial networks. Generative networks may be used to generate new data such as artificial feedback texts.

In an example in which the input data does not include feature embeddings, one or more neural networks may be used to provide an embedding based on the input data. For example, the embedding may be a representation of knowledge abstracted from the input data into one or more learned dimensions. In some instances, embeddings may be a useful source for identifying related entities. In some instances, embeddings may be extracted from the output of the network, while in other instances embeddings may be extracted from any hidden node or layer of the network (e.g., a close to final but not final layer of the network). Embeddings may be useful for performing auto-suggest next video, product suggestion, entity or object recognition, etc. In some instances, embeddings are useful inputs for downstream models. For example, embeddings may be useful to generalize input data (e.g., search queries) for a downstream model or processing system.

In some implementations, machine learning module 210 may perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, machine learning module 210 may be an autoregressive model. In some instances, an autoregressive model may specify that the output data depends linearly on its own previous values and on a stochastic term. In some instances, an autoregressive model may take the form of a stochastic difference equation. One example of an autoregressive model is WaveNet, which is a generative model for raw audio.

In some implementations, machine learning module 210 may include or form part of a multiple model ensemble. As one example, bootstrap aggregating may be performed, which may also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models may be combined (e.g., through averaging, voting, or other techniques) and used as the output of the ensemble.

One example ensemble is a random forest, which may also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees may be used as the output of the forest. Random decision forests may correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of the same or different type) may be trained based on training data. In addition, a combiner model may be trained to take the predictions from the other machine-learned models as inputs and, in response, produce a final inference or prediction. In some instances, a single-layer logistic regression model may be used as the combiner model.

Another example of ensemble techniques is boosting. Boosting may include incrementally building an ensemble by iteratively training weak models and then adding to a final strong model. For example, in some instances, each new model may be trained to emphasize the training examples that previous models misinterpreted (e.g., misclassified). For example, a weight associated with each of such misinterpreted examples may be increased. One common implementation of boosting is AdaBoost, which may also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) may be combined to form an ensemble. As an example, an ensemble may include a top-level machine-learned model or a heuristic function to combine and/or weight the outputs of the models that form the ensemble.

In some implementations, multiple machine-learned models (e.g., that form an ensemble may be linked and trained jointly (e.g., through backpropagation of errors sequentially through the model ensemble). However, in some implementations, only a subset (e.g., one) of the jointly trained models is used for inference.

In some implementations, machine learning module 210 may be used to preprocess the input data for subsequent input into another model. For example, machine learning module 210 may perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

In some implementations, during training, the input data may be intentionally deformed in any number of ways to increase model robustness, generalization, or other qualities. Example techniques to deform the input data include adding noise; changing color, shade, or hue; magnification; segmentation; amplification; etc.

In response to receipt of the input data, machine learning module 210 may provide the output data. As examples, in various implementations, the output data may include content, either stored locally on the user device or in the cloud, that is relevantly shareable along with the initial content selection.

In some implementations, the output data may influence downstream processes or decision-making. As one example, in some implementations, the output data, or the summary of the content, may be interpreted and/or acted upon by a rules-based regulator.

The techniques of the present disclosure may be implemented by or otherwise executed on one or more computing devices (e.g., computing device 112 of FIG. 1). Examples of such computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 200 that implements machine learning module 210 or other aspects of the present disclosure may include a number of hardware components that enable the performance of the techniques described herein.

Machine learning module 210 described herein may be trained according to one or more of various different training types or techniques. For example, in some implementations, machine learning module 210 may be trained using supervised learning, in which machine learning module 210 is trained on a training dataset that includes instances or examples that have labels. The labels may be manually applied by experts, generated through crowdsourcing, or provided by other techniques (e.g., by physics-based or complex mathematical models). In some implementations, if the user has provided consent, the training examples may be provided by the user computing device. In some implementations, this process may be referred to as personalizing the model.

In some implementations, backward propagation of errors may be used in conjunction with an optimization technique (e.g., gradient-based techniques) to train machine learning module 210 (e.g., when the machine-learned model is a multi-layer model such as an artificial neural network). For example, an iterative cycle of propagation and model parameter (e.g., weights) update may be performed to train machine learning module 210. Example backpropagation techniques include truncated backpropagation through time, Levenberg- Marquardt backpropagation, etc.

In some implementations, machine learning module 210 described herein may be trained using unsupervised learning techniques. Unsupervised learning may include inferring a function to describe hidden structure from unlabeled data. For example, a classification or categorization may not be included in the data. Unsupervised learning techniques may be used to produce machine-learned models capable of performing clustering, anomaly detection, learning latent variable models, or other tasks.

Machine learning module 210 may be trained using semi-supervised techniques which combine aspects of supervised learning and unsupervised learning. Machine learning module 210 may be trained or otherwise generated through evolutionary techniques or genetic algorithms. In some implementations, machine learning module 210 described herein may be trained using reinforcement learning. In reinforcement learning, an agent (e.g., model) may take actions in an environment and learn to maximize rewards and/or minimize penalties that result from such actions. Reinforcement learning may differ from the supervised learning problem in that correct input/output pairs are not presented, nor sub-optimal actions explicitly corrected.

In some implementations, one or more generalization techniques may be performed during training to improve the generalization of machine learning module 210. Generalization techniques may help reduce overfitting of machine learning module 210 to the training data. Example generalization techniques include dropout techniques; weight decay techniques; batch normalization; early stopping; subset selection; stepwise selection; label smoothing; etc.

In some implementations, machine learning module 210 described herein may include or otherwise be impacted by a number of hyperparameters, such as, for example, learning rate, number of layers, number of nodes in each layer, number of leaves in a tree, number of clusters; etc. Hyperparameters may affect model performance. Hyperparameters may be hand selected or may be automatically selected through the application of techniques such as, for example, grid search; black-box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques may be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques may be used to provide an initial model from which to begin training of machine learning module 210 described herein.

In some implementations, machine learning module 210 described herein may be included in different portions of computer-readable code on a computing device. In one example, machine learning module 210 may be included in a particular application or program and used (e.g., exclusively) by such particular application or program. Thus, in one example, a computing device may include a number of applications, and one or more of such applications may contain its own respective machine learning library and machine-learned model(s).

In another example, machine learning module 210 described herein may be included in an operating system of a computing device (e.g., in a central intelligence layer of an operating system) and may be called or otherwise used by one or more applications that interact with the operating system. In some implementations, each application may communicate with the central intelligence layer (and model(s) stored therein) using an application programming interface (API) (e.g., a common, public API across all applications).

In some implementations, the central intelligence layer may communicate with a central device data layer. The central device data layer may be a centralized repository of data for the computing device. The central device data layer may communicate with a number of other components of the computing device, such as, for example, one or more sensors, a context manager, a device state component, and/or additional components. In some implementations, the central device data layer may communicate with each device component using an API (e.g., a private API).

The technology discussed herein refers to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination.

Databases and applications may be implemented on a single system or distributed across multiple systems. Distributed components may operate sequentially or in parallel.

In addition, the machine learning techniques described herein are readily interchangeable and combinable. Although certain example techniques have been described, many others exist and may be used in conjunction with aspects of the present disclosure.

In some implementations, transfer learning (TL) may be used. Transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In this way, machine learning module 210 may apply at least a transcript matching model, in combination with or not in combination with one or more of the machine learning techniques described above, to the transcript and a current timestamp of the video to identify one or more noncurrent time stamps. Machine learning module 210 may further apply a model, in combination with or not in combination with one or more of the machine learning techniques described above, to the transcript, the current timestamp, and the one or more noncurrent time stamps to rank, based on user data, the one or more noncurrent time stamps. In some examples, the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

Computing system 200 may then adjust, based on the ranking of the one or more noncurrent timestamps, the playback position to a noncurrent timestamp from the one or more noncurrent timestamps. In some examples, the noncurrent timestamp is a first-ranked noncurrent timestamp. As such, the video playback may be adjusted based on user preferences and intelligent video processing, rather than fixed time intervals that may overshoot and worsen user experience.

FIG. 3 is a conceptual diagram illustrating an example machine learning module for adjusting playback position of a video based on user data and the video transcript, in accordance with one or more techniques of this disclosure.

As described above, ML module 310 can be or include one or more machine learning models, such as transcript matching model 352 and user preference model 353. In some examples, a single model (e.g., a single model trained end-to-end) may perform the machine learning techniques described herein with respect to one or more of the machine learning model configured to generate an augmented transcript, transcript matching model 352, and user preference model 353, and/or other machine learning techniques described herein. In general, transcript matching model 352 may employ speech-to-text engines, alignment algorithms, natural language processing (NLP), and timestamping, to synchronize and provide accurate video transcripts. In some examples, transcript matching model 352 may process an audio file included in the video information retrieved by computing system 300 to extract features such as phonemes and other acoustic signals.

Although many examples provided throughout this disclosure describe transcript matching model 352 receiving a transcript as input, in some examples, transcript matching model 352 may be configured to output a transcript. Specifically, in some examples, transcript matching model 352 may perform speech recognition, in which transcript matching model 352 may convert spoken words or dialogue in an audio recording to text. For example, transcript matching model 352 may employ a speech-to-text engine that converts audio data into text data. In some examples, transcript matching model 352 may employ one or more alignment algorithms that may better align generated text data with the audio data, such as Dynamic Time Warping (DTW) or Hidden Markov Models (HMMs). In this way, transcript matching model 352 may synchronize subtitles or captions with dialogue in a video, such as to accurately time spoken words in the audio data. In some examples, transcript matching model 352 may perform timestamping, in which time markers may be added to the transcript to indicate when each word or sentence is spoken in an audio or video. In some examples, transcript matching model 352 may be an LLM, or another model capable of performing NLP tasks, such as machine translation, text summarization, sentiment analysis, etc.

In some examples, transcript matching model 352 may be configured to perform tasks such as classification, sentiment analysis, entity extraction, extractive question answering, summarization, re-writing text in a different style, ad copy generation, and concept ideation.

In some examples, transcript matching model 352 may involve or be used in conjunction with transformer-based neural networks that utilize a self-attention mechanism, which may allow the model to weigh the importance of different elements in a given input sequence relative to each other. The self-attention mechanism may help transcript matching model 352 effectively capture long-range dependencies and complex relationships between elements, such as words in a sentence.

Transcript matching model 352 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In general, transcript matching model 352 may take a video transcript and a current timestamp of the video as input, and then identify one or more noncurrent timestamps of the video, such as a start time stamp for a current sentence, a start time stamp for a current dialogue, a start time stamp for a current scene, start time stamp for a future sentence, a start time stamp for a future dialogue, and a start time stamp for a future scene.

In some examples, transcript matching model 352 may leverage a self-attention mechanism to capture the relationships and dependencies between words in an input sequence. For example, transcript matching model 352 may tokenize (e.g., split) a sequence of words or subwords, which transcript matching model 352 may convert into vectors (e.g., numerical representations) that transcript matching model 352 can process. Transcript matching model 352 may use the self-attention mechanism to weigh the importance of each token in relation to the others. In this way, transcript matching model 352 may identify patterns and relationships between the tokens, and in turn the words corresponding to the tokens, that may indicate information pertaining to a video, such as the start of a sentence, scene, dialogue, etc. In general, transcript matching model 352 may excel at performing NLP tasks, such as generating and/or interpreting text and other content.

Although primarily described herein as being an NLP model, as described above, transcript matching model 352 may be or otherwise include one or more other types of models, such as other neural networks. For example, transcript matching model 352 may be or include an autoencoder. In some examples, the aim of an autoencoder is to learn a representation (e.g., a lower- dimensional encoding) for a set of data, typically for the purpose of dimensionality reduction. For example, in some examples, an autoencoder can seek to encode the input data and then provide output data that reconstructs the input data from the encoding. Recently, the autoencoder concept has become more widely used for learning generative models of data. In some examples, the autoencoder can include additional losses beyond reconstructing the input data. Transcript matching model 352 may be or include one or more other forms of artificial neural networks such as, for example, deep Boltzmann machines, deep belief networks, stacked autoencoders, etc. Any of the neural networks described herein can be combined (e.g., stacked) to form more complex networks.

In some examples, transcript matching model 352 can be or include one or more feed forward neural networks. In feed forward networks, the connections between nodes do not form a cycle. For example, each connection can connect a node from an earlier layer to a node from a later layer. In some examples, transcript matching model 352 can be or include one or more recurrent neural networks. In some examples, at least some of the nodes of a recurrent neural network can form a cycle.

Recurrent neural networks can be especially useful for processing input data that is sequential in nature. For example, a recurrent neural network can pass or retain information from a previous portion of the input data sequence to a subsequent portion of the input data sequence through the use of recurrent or directed cyclical node connections. Sequential input data may include words in a sentence (e.g., for natural language processing, speech detection or processing, etc.). In some examples, sequential input data can include time-series data (e.g., sensor data versus time or imagery captured at different times). In some examples, sequential input data may include time-series data (e.g., sensor data versus time or imagery captured at different times). Sequential input data may include words in a sentence (e.g., for natural language processing, speech detection or processing, etc.), notes in a musical composition, etc.

Example recurrent neural networks may include long short-term (LSTM) recurrent neural networks, gated recurrent units, bi-direction recurrent neural networks, continuous time recurrent neural networks, neural history compressors, echo state networks, Elman networks, Jordan networks, recursive neural networks, Hopfield networks, fully recurrent networks, sequence-to- sequence configurations, etc.

In some examples, transcript matching model 352 can be or include one or more convolutional neural networks. In some examples, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

As described above, transcript matching model 352 may perform timestamping. As such, transcript matching model 352 may identify one or more noncurrent time stamps based on the transcript or augmented transcript (in which the transcript may be retrieved by the computing system, generated by transcript matching model 352, or generated by another machine learning model described herein) and the current timestamp of the video (e.g., timestamp 117 of FIG. 1). In general, user preference model 353 may be employed by ML module 310 to rank, based on user data stored in user data storage 342, the one or more noncurrent time stamps identified by transcript matching model 352. Specifically, user preference model 353 may take the transcript (and/or the augmented transcript), the current timestamp, and the one or more noncurrent timestamps as input, and provide a ranking of the noncurrent timestamps as output.

As described herein, user preference model 353 may be trained on various data stored in user data storage 342. In some examples, user preference model 353 may be trained on user feedback such as ratings, likes, dislikes, and preferences explicitly stated in surveys or profiles. In some examples, user preference model 353 may be trained on user behavioral data determined from previous user inputs or interactions. User preference model 353 may employ various machine learning techniques described herein to determine a ranking of the noncurrent timestamps based on user preferences. For example, in some examples, user preference model 353 may employ collaborative filtering that uses patterns of behavior from similar users to predict preferences. In some examples, user preference model 353 may employ content-based filtering that determines preferences based on user satisfaction levels associated with past video playback adjustments. User preference model 353 may employ machine learning algorithms such as matrix factorization, deep learning, and clustering to model user preferences. In general, user preference model 353 may predict user preferences based on identified patterns in user data, and then rank the one or more noncurrent timestamps based on the predicted preferences.

Machine learning module 310 may include training module 350 that trains (e.g., pre-train, fine-tune, etc.) user preference model 353 and/or transcript matching model 352. As an example, training module 350 may pre-train transcript matching model 352 on a large and diverse corpus of text. This dataset may cover a wide range of topics and domains to ensure transcript matching model 352 learns diverse linguistic patterns and contextual relationships. Training module 350 may train models employed by ML module 310 to optimize an objective function. The objective function may be or include a loss function, such as cross-entropy loss, that compares (e.g., determines a difference between) output data generated by the model from the training data and labels (e.g., ground-truth labels) associated with the training data. For example, the objective function of transcript matching model 352 may be to correctly identify the beginning of a sentence or dialogue. As another example, the objective function of user preference model 353 may be to achieve a threshold satisfaction level for the user based on input indicative of additional requests to adjust a playback position of the video.

In some examples, training module 350 may continuously or periodically train transcript matching model 352 and user preference model 353. In some examples, training module 350 may fine-tune transcript matching model 352 and user preference model 353 by using feedback in the training process. For example, UI component 232 of FIG. 2 may receive the additional input indicative of additional requests to adjust a playback position of the video. UI module 204 may receive this feedback and may send it to ML module 310 (specifically to training module 350), in which training module 350 uses the feedback for training. Furthermore, the computing system may adjust the playback position to a different noncurrent timestamp from the one or more noncurrent timestamps, such as a second-ranked noncurrent timestamp. User data, including feedback data, may be stored in user data storage 342 and may be used to train user preference model 353, such that user preferences are better determined. For example, the user data may include data indicative of a number of requests for rewinding the video and/or a number of requests for fast-forwarding the video, such that user preference model 353 may learn a ranking of timestamps that is more likely to satisfy the user.

In some examples, training module 350 may convert the feedback into labeled data for supervised training. Additionally, or alternatively, training module 350 may fine-tune transcript matching model 352 and user preference model 353 by monitoring the relationship between the performance of transcript matching model 352, user preference model 353, and user feedback, and iterate the fine-tuning process as necessary (e.g., to receive more positive user feedback and less negative user feedback). In this way, the techniques of this disclosure may establish a feedback loop that continuously improves the quality of the output (i.e., the adjusted playback position of a video) of transcript matching model 352 and user preference model 353.

As described above, the techniques described herein may all be implemented locally on a computing device. For example, a computing device may retrieve, using an application programming interface, video information including a video transcript. The computing device may also receive an input indicative of a request to adjust a playback position of the video, in which the request does not specify a timestamp of the video to which to adjust the playback position. The computing device may then apply the models described above with respect to machine learning module 310 to adjust, based on a ranking of the one or more noncurrent timestamps, the playback position of the video.

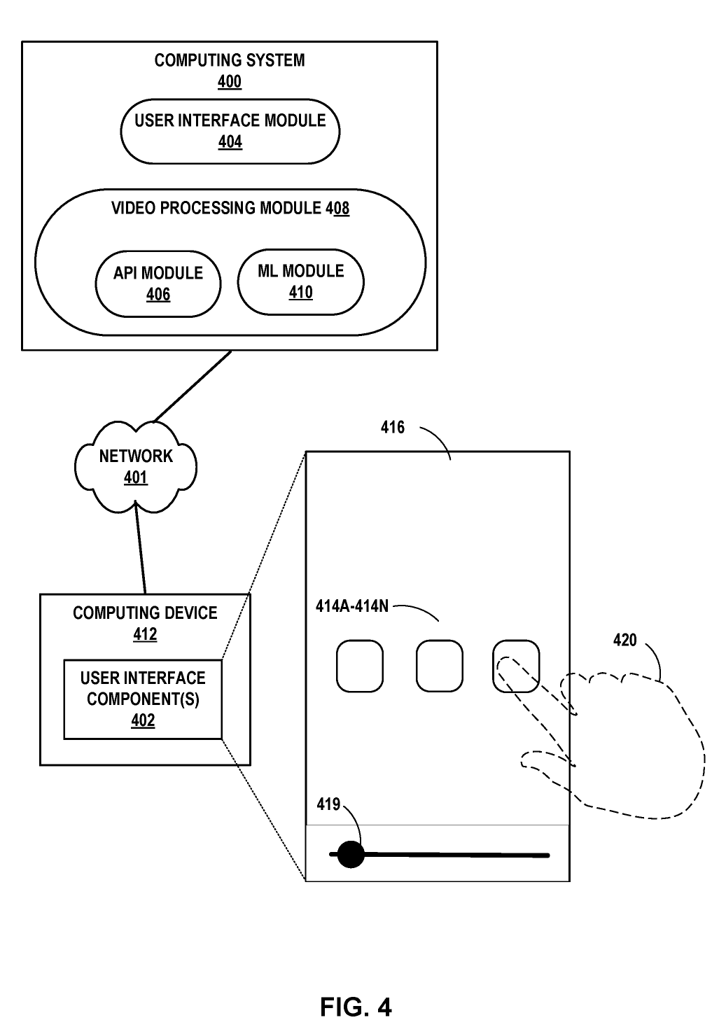

FIG. 4 is another conceptual diagram illustrating an example computing system configured to adjust playback position of a video based on user data and the video transcript, in accordance with one or more techniques of this disclosure. Computing system 400, user interface module 404, video processing module 408, API module 406, machine learning module 410, network 401, computing device 412, (UI) components 402, GUI 416, and buttons 414A-414N may be similar if not substantially similar to computing system 100, user interface module 104, video processing module 108, API module 106, machine learning module 110, network 101, computing device 112, (UI) components 102, GUI 116, and buttons 114A-114N of FIG. 1, respectively.

As shown in the example of FIG. 4, computing system 400 may adjust, based on the ranking of the one or more noncurrent timestamps as determined by ML module 410, the playback position of the video displayed by GUI 416 to noncurrent timestamp 419. As described herein, ML module 410 may rank one or more noncurrent timestamps based on user data indicating user preferences for adjusting video playback. For example, if historical user data indicates a user frequently rewinds to the beginning of scenes, a start timestamp corresponding to the beginning of a current scene may be determined as a first-ranked noncurrent timestamp by ML module 410. Thus, in some examples, timestamp 419 may be a first-ranked noncurrent timestamp. In some examples, however, as described above, computing system 400 may receive, from computing device 412, user data including data indicative of one or more of a number of requests for rewinding the video and a number of requests for fast-forwarding the video. For example, after computing system 400 adjusts the video playback to timestamp 419, user 420 may provide an additional input indicative of an additional request to adjust the playback position of the video (e.g., by interacting with one or more of buttons 414A-414N). For example, user 420 may provide the additional request (e.g., a request to rewind again) if timestamp 419 is not user 420’s desired timestamp.

Responsive to receiving a second input indicative of a request to adjust a playback position of the video, computing system 400 may adjust, based on the ranking of the one or more noncurrent timestamps, the playback position to a second noncurrent timestamp from the one or more noncurrent timestamps (e.g., a timestamp that is different from timestamp 419). In some examples, the second noncurrent timestamp is a second-ranked noncurrent timestamp. Furthermore, as described above, computing system 400 may provide this additional input as feedback to ML module 410 to better understand user preferences, in which the user preference model and other models described herein may be trained on the user data.

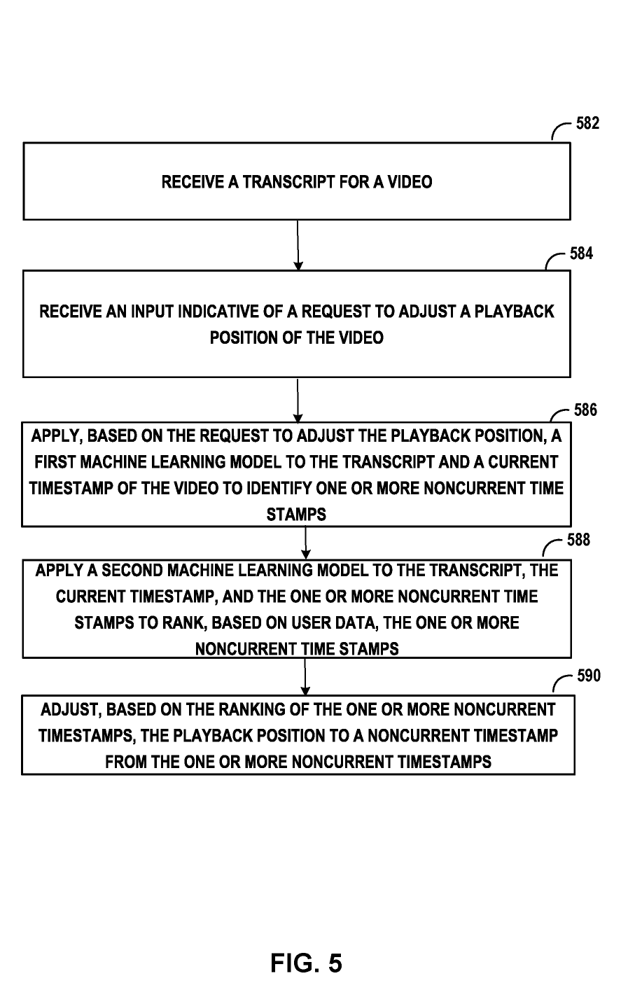

FIG. 5 is a flowchart illustrating an example operation of a computing system configured to receive user input indicating a request to adjust a playback position of a video, in accordance with one or more techniques of this disclosure. For the purposes of clarity, the operation of FIG. 5 is discussed in reference to FIGS. 1-4.

Computing system 100 receives a transcript for a video (582). In some examples, computing system 100 retrieves, using an application programming interface generated by API module 106, video information including the transcript and visual data. In some examples, ML module 110 of computing system 100 applies a machine learning model to the transcript to generate an augmented transcript including information indicative of one or more scenes included in the video. In these examples, computing system 100 may provide the augmented transcript to another machine learning model implemented by ML module 110 as input.

Computing system 100 receives an input indicative of a request to adjust a playback position of the video, in which the request does not specify a timestamp of the video to which to adjust the playback position (584). In some examples, user 120 operating computing device 112 may provide the input by interacting with one of buttons 114A-114N of GUI 116, in which each of buttons 114A-114N may correspond to a video playback feature.

Computing system 100 applies, based on the request to adjust the playback position, transcript matching model 352 to the transcript and a current timestamp of the video to identify one or more noncurrent time stamps (586). In some examples, the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

Computing system 100 applies user preference model 353 to the transcript, the current timestamp, and the one or more noncurrent time stamps to rank, based on user data stored in user data storage 342, the one or more noncurrent time stamps (588). In some examples, the user data stored in user data storage 342 includes data indicative of one or more of a number of requests for rewinding the video and a number of requests for fast-forwarding the video. In some examples, user preference model 353 is trained on the user data stored in user data storage 342. In some examples, transcript matching model 352 and user preference model 353 are the same machine learning model.

Computing system 100 adjusts, based on the ranking of the one or more noncurrent timestamps, the playback position to noncurrent timestamp 419 from the one or more noncurrent timestamps (590). In some examples, noncurrent timestamp 419 is a first-ranked noncurrent timestamp. In some examples, the input indicative of the request is a first input, and the noncurrent timestamp is a first noncurrent timestamp. In these examples, responsive to receiving a second input indicative of a request to adjust a playback position of the video, computing system 100 adjusts, based on the ranking of the one or more noncurrent timestamps, the playback position to a second noncurrent timestamp from the one or more noncurrent timestamps. In some examples, the second noncurrent timestamp is a second-ranked noncurrent timestamp.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Example 1: A method includes receiving, by a computing system, a transcript for a video; receiving, by the computing system, an input indicative of a request to adjust a playback position of the video, wherein the request does not specify a timestamp of the video to which to adjust the playback position; applying, by the computing system, and based on the request to adjust the playback position, a first machine learning model to the transcript and a current timestamp of the video to identify one or more noncurrent time stamps; applying, by the computing system, a second machine learning model to the transcript, the current timestamp, and the one or more noncurrent time stamps to rank, based on user data, the one or more noncurrent time stamps; and adjusting, by the computing system and based on the ranking of the one or more noncurrent timestamps, the playback position to a noncurrent timestamp from the one or more noncurrent timestamps.

Example 2: The method of example 1, wherein the noncurrent time stamp is a first-ranked noncurrent timestamp.

Example 3: The method of examples 1 or 2, wherein the input indicative of the request is a first input, wherein the noncurrent timestamp is a first noncurrent timestamp, the method further comprising: responsive to receiving a second input indicative of a request to adjust a playback position of the video, adjusting, by the computing system and based on the ranking of the one or more noncurrent timestamps, the playback position to a second noncurrent timestamp from the one or more noncurrent timestamps.

Example 4: The method of example 3, wherein the second noncurrent timestamp is a second-ranked noncurrent timestamp.

Example 5: The method of any of examples 1 through 4, wherein the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

Example 6: The method of any of examples 1 through 5, wherein the user data includes data indicative of one or more of a number of requests for rewinding the video and a number of requests for fast-forwarding the video, and wherein the second machine learning model is trained on the user data.

Example 7: The method of any of examples 1 through 6, further comprising: applying, by the computing system, a third machine learning model to the transcript to generate an augmented transcript including information indicative of one or more scenes included in the video; and providing, by the computing system, the augmented transcript to the first machine learning model as input.

Example 8: The method of any of examples 1-7, wherein the first machine learning model and the second machine learning model are the same machine learning model.

Example 9: The method of any of examples 1 through 8, wherein the first machine learning model is a transcript matching model.

Example 10: A computing system includes: one or more processors; and one or more storage devices that store instructions, wherein the instructions, when executed by the one or more processors, cause the one or more processors to: receive a transcript for a video; receive an input indicative of a request to adjust a playback position of the video, wherein the request does not specify a timestamp of the video to which to adjust the playback position; apply, based on the request to adjust the playback position, a first machine learning model to the transcript and a current timestamp of the video to identify one or more noncurrent time stamps; apply a second machine learning model to the transcript, the current timestamp, and the one or more noncurrent time stamps to rank, based on user data, the one or more noncurrent time stamps; and adjust, based on the ranking of the one or more noncurrent timestamps, the playback position to a noncurrent timestamp from the one or more noncurrent timestamps.

Example 11: The computing system of example 10, wherein the noncurrent time stamp is a first-ranked noncurrent timestamp.

Example 12: The computing system of examples 10 or 11, wherein the input indicative of the request is a first input, wherein the noncurrent timestamp is a first noncurrent timestamp, and wherein the instructions further cause the one or more processors to: responsive to receiving a second input indicative of a request to adjust a playback position of the video, adjust, based on the ranking of the one or more noncurrent timestamps, the playback position to a second noncurrent timestamp from the one or more noncurrent timestamps.

Example 13: The computing system of example 12, wherein the second noncurrent timestamp is a second-ranked noncurrent timestamp.

Example 14: The computing system of any of examples 10 through 13, wherein the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

Example 15: The computing system of any of examples 10 through 14, wherein the user data includes data indicative of one or more of a number of requests for rewinding the video and a number of requests for fast-forwarding the video, and wherein the second machine learning model is trained on the user data.

Example 16: The computing system of any of examples 10 through 15, wherein the instructions further cause the one or more processors to: apply a third machine learning model to the transcript to generate an augmented transcript including information indicative of one or more scenes included in the video; and provide the augmented transcript to the first machine learning model as input.

Example 17: The computing system of any of examples 10-17, wherein the first machine learning model and the second machine learning model are the same machine learning model.

Example 18: The computing system of any of examples 10 through 17, wherein the first machine learning model is a transcript matching model.

Example 19: A non-transitory computer-readable storage medium encoded with instructions that, when executed by one or more processors, cause one or more processors to: receive a transcript for a video; receive an input indicative of a request to adjust a playback position of the video, wherein the request does not specify a timestamp of the video to which to adjust the playback position; apply, based on the request to adjust the playback position, a first machine learning model to the transcript and a current timestamp of the video to identify one or more noncurrent time stamps; apply a second machine learning model to the transcript, the current timestamp, and the one or more noncurrent time stamps to rank, based on user data, the one or more noncurrent time stamps; and adjust, based on the ranking of the one or more noncurrent timestamps, the playback position to a noncurrent timestamp from the one or more noncurrent timestamps.

Example 20: The non-transitory computer-readable medium of example 19, wherein the noncurrent time stamp is a first-ranked noncurrent timestamp.

Example 21: The non-transitory computer-readable medium of examples 19 or 20, wherein the input indicative of the request is a first input, wherein the noncurrent timestamp is a first noncurrent timestamp, and wherein the instructions further cause the one or more processors to: responsive to receiving a second input indicative of a request to adjust a playback position of the video, adjust, based on the ranking of the one or more noncurrent timestamps, the playback position to a second noncurrent timestamp from the one or more noncurrent timestamps.

Example 22: The non-transitory computer-readable medium of example 21, wherein the second noncurrent timestamp is a second-ranked noncurrent timestamp.

Example 23: The non-transitory computer-readable medium of any of examples 19 through 22, wherein the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

Example 24: The non-transitory computer-readable medium of any of examples 19 through 23, wherein the user data includes data indicative of one or more of a number of requests for rewinding the video and a number of requests for fast-forwarding the video, and wherein the second machine learning model is trained on the user data.

Example 25: The non-transitory computer-readable medium of any of examples 19 through 24, wherein the instructions further cause the one or more processors to: apply a third machine learning model to the transcript to generate an augmented transcript including information indicative of one or more scenes included in the video; and provide the augmented transcript to the first machine learning model as input.

Example 26: The non-transitory computer-readable medium of any of examples 19-25, wherein the first machine learning model and the second machine learning model are the same machine learning model.

Example 27: The non-transitory computer-readable medium of any of examples 19 through 26, wherein the first machine learning model is a transcript matching model.

Various examples have been described. These and other examples are within the scope of the following claims.

What is claimed is:

1. A method comprising:
receiving, by a computing system, a transcript for a video;
receiving, by the computing system, an input indicative of a request to adjust a playback position of the video, wherein the request does not specify a timestamp of the video to which to adjust the playback position;
applying, by the computing system, and based on the request to adjust the playback position, a first machine learning model to the transcript and a current timestamp of the video to identify one or more noncurrent time stamps;
applying, by the computing system, a second machine learning model to the transcript, the current timestamp, and the one or more noncurrent time stamps to rank, based on user data, the one or more noncurrent time stamps; and
adjusting, by the computing system and based on the ranking of the one or more noncurrent timestamps, the playback position to a noncurrent timestamp from the one or more noncurrent timestamps.

2. The method of claim 1, wherein the noncurrent time stamp is a first-ranked noncurrent timestamp.

3. The method of claim 1, wherein the input indicative of the request is a first input, wherein the noncurrent timestamp is a first noncurrent timestamp, the method further comprising:
responsive to receiving a second input indicative of a request to adjust a playback position of the video, adjusting, by the computing system and based on the ranking of the one or more noncurrent timestamps, the playback position to a second noncurrent timestamp from the one or more noncurrent timestamps.

4. The method of claim 3, wherein the second noncurrent timestamp is a second-ranked noncurrent timestamp.

5. The method of claim 1, wherein the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

6. The method of claim 1, wherein the user data includes data indicative of one or more of a number of requests for rewinding the video and a number of requests for fast-forwarding the video, and wherein the second machine learning model is trained on the user data.

7. The method of claim 1, further comprising:
applying, by the computing system, a third machine learning model to the transcript to generate an augmented transcript including information indicative of one or more scenes included in the video; and
providing, by the computing system, the augmented transcript to the first machine learning model as input.

8. The method of claim 1, wherein the first machine learning model and the second machine learning model are the same machine learning model.

9. The method of claim 1, wherein the first machine learning model is a transcript matching model.

10. A computing system comprising:
one or more processors; and
one or more storage devices that store instructions, wherein the instructions, when executed by the one or more processors, cause the one or more processors to:
receive a transcript for a video;
receive an input indicative of a request to adjust a playback position of the video, wherein the request does not specify a timestamp of the video to which to adjust the playback position;
apply, based on the request to adjust the playback position, a first machine learning model to the transcript and a current timestamp of the video to identify one or more noncurrent time stamps;
apply a second machine learning model to the transcript, the current timestamp, and the one or more noncurrent time stamps to rank, based on user data, the one or more noncurrent time stamps; and
adjust, based on the ranking of the one or more noncurrent timestamps, the playback position to a noncurrent timestamp from the one or more noncurrent timestamps.

11. The computing system of claim 10, wherein the noncurrent time stamp is a first-ranked noncurrent timestamp.

12. The computing system of claim 10, wherein the input indicative of the request is a first input, wherein the noncurrent timestamp is a first noncurrent timestamp, and wherein the instructions further cause the one or more processors to:
responsive to receiving a second input indicative of a request to adjust a playback position of the video, adjust, based on the ranking of the one or more noncurrent timestamps, the playback position to a second noncurrent timestamp from the one or more noncurrent timestamps.

13. The computing system of claim 12, wherein the second noncurrent timestamp is a second-ranked noncurrent timestamp.

14. The computing system of claim 10, wherein the one or more noncurrent time stamps include at least one of a start time stamp for a current sentence, a start time stamp for a current dialogue, a start time stamp for a current scene, start time stamp for a future sentence, a start time stamp for a future dialogue, and a start time stamp for a future scene.

15. The computing system of claim 10, wherein the user data includes data indicative of one or more of a number of requests for rewinding the video and a number of requests for fast-forwarding the video, and wherein the second machine learning model is trained on the user data.

16. The computing system of claim 10, wherein the instructions further cause the one or more processors to:
apply a third machine learning model to the transcript to generate an augmented transcript including information indicative of one or more scenes included in the video; and
provide the augmented transcript to the first machine learning model as input.

17. The computing system of claim 10, wherein the first machine learning model and the second machine learning model are the same machine learning model.

18. The computing system of claim 10, wherein the first machine learning model is a transcript matching model.

19. A non-transitory computer-readable storage medium encoded with instructions that, when executed by one or more processors, cause one or more processors to:
receive a transcript for a video;
receive an input indicative of a request to adjust a playback position of the video, wherein the request does not specify a timestamp of the video to which to adjust the playback position;
apply, based on the request to adjust the playback position, a first machine learning model to the transcript and a current timestamp of the video to identify one or more noncurrent time stamps;
apply a second machine learning model to the transcript, the current timestamp, and the one or more noncurrent time stamps to rank, based on user data, the one or more noncurrent time stamps; and
adjust, based on the ranking of the one or more noncurrent timestamps, the playback position to a noncurrent timestamp from the one or more noncurrent timestamps.

20. The non-transitory computer-readable storage medium of claim 19, wherein the input indicative of the request is a first input, wherein the noncurrent timestamp is a first noncurrent timestamp, and wherein the instructions further cause the one or more processors to:
responsive to receiving a second input indicative of a request to adjust a playback position of the video, adjust, based on the ranking of the one or more noncurrent timestamps, the playback position to a second noncurrent timestamp from the one or more noncurrent timestamps.
